(19) United States
(12) Patent Application Publication
(10) Pub. No.: US 2015/0333790 A1
(43) Pub. Date: Nov. 19, 2015

(54) A MOBILE TELEPHONE SHELL AND A MOBILE TERMINAL

(71) Applicant: Orange, Paris (FR)

(72) Inventors: Philippe Magliulo, Cresserons (FR); Philippe Levionnais, Caen (FR)

(21) Appl. No.: 14/389,343

(22) PCT Filed: Feb. 22, 2013
(86) PCT No.: PCT/FR2013/050374

§ 371 Date: Sep. 29, 2014

(30) Foreign Application Priority Data
Mar. 30, 2012 (FR) 1252966

(51) Int. Cl. H04B 1/3888; H04M 1/725; H04W 4/00; H04M 1/04

(52) U.S. Cl. CPC H04B 1/3888; H04M 1/04; H04M 1/7253; H04W 4/008; H04M 2250/04

(57) ABSTRACT

In one embodiment, a shell is provided. In one embodiment, the shell is arranged to receive a mobile telephone in removable manner, the telephone having a slot in a lateral edge enabling a subscriber identity card to be inserted therein. The shell may comprise a holder arranged on a bottom-forming wall of the shell to receive and hold a near field communication device and an associated antenna, a wire interface having a first end for connection to the device and a second end provided with electrical contacts, and a support having the second end fastened thereto and adapted to receive the subscriber identity card so as to connect said contacts with corresponding electrical contacts of the card. In an embodiment, the assembly as formed by the support on which the second end is fastened and having the card received on the support is adapted to be inserted in the slot.

### BACKGROUND OF THE INVENTION

The invention relates to the general field of telecommunications.

It relates more particularly to so-called “contactless” communications technologies, such as for example near field communication (NFC) technologies, and it relates to using them in mobile communications terminals for performing so-called “contactless” applications.

Contactless applications relying on NFC technologies have been developed for example to perform electronic transactions in the fields of banking or of public transport, or indeed in applications relating to identification or controlling access.

In general, in such NFC applications, near field communication is established between two NFC entities that are not in contact: for this purpose, each NFC entity has a near field communication device (or NFC device) associated with an antenna enabling contactless communication to be established with the other NFC entity. Below in this document, the term “NFC device” is used to mean an assembly comprising an NFC component together with other electronic components enabling it to perform in a circuit for using it, such as for example capacitors and/or resistors.

In one operating mode, one of the NFC entities acts as a contactless card, while the other entity acts as a contactless card reader. Examples of contactless NFC entities acting in such an operating mode are radiofrequency identification (RFID) tags and an RFID tag reader.

It is also possible to envisage another peer-to-peer (P2P) operating mode in which the contactless NFC entities perform equivalent roles and operate as contactless cards exchanging data locally.

In the present state of the art, there exist systems enabling the functions of an NFC entity (i.e. a contactless card and/or a contactless card reader) to be provided for a mobile terminal having a subscriber identity card (also known as a subscriber identity module (SIM)), and enabling these NFC functions to co-operate with the mobile telephony functions of the terminal.

In those systems, contactless applications are generally installed in the subscriber identity card of the mobile terminal, since they require a degree of security. Furthermore, the mobile terminal has an NFC device together with its associated antenna, so as to enable the mobile terminal as transformed in this way into a contactless NFC entity to dialog with another contactless entity situated in the proximity of the terminal.

In certain systems in the state of the art, the NFC device is soldered to a printed circuit of the mobile terminal.

That gives rise to the mobile terminal being of architecture that is rigid, preventing the user of the mobile terminal from changing mobile terminal independently of the component that provides the terminal with contactless functions.

Document WO 2011/148087 describes an alternative system presenting architecture that is more flexible, in which the NFC device is connected via a wire interface to the mobile terminal solely via the SIM card. The wire interface may for example be an NFC sheet made of plastics material and containing a plurality of connection wires within the plastics material.

More precisely, Document WO 2011/148087 describes a shell designed to be fastened against the rear face of a mobile telephone in releasable manner, and it is suitable for adapting to an existing mobile telephone in order to make it capable of providing NFC functions.

The shell is designed to receive and hold an NFC device together with its associated antenna against its inside surface, and it includes means, e.g. such as a setback, for guiding the wire interface connecting the NFC device to the SIM card.

The wire interface is taken to a slot arranged in a lateral edge of the telephone for the purpose of enabling the SIM card to be inserted in the mobile telephone with the help of an appropriate support, also known as a SIM card tray.

The SIM card is received in the tray and the tray is put into the mobile telephone through the slot, thereby taking with it the end of the wire interface that is connected to the SIM card inside the mobile telephone.

The portion of the wire interface that extends along the lateral edge of the telephone and that lies between the shell and the slot is particularly vulnerable and fragile. In order to protect this portion and avoid damaging it during clumsy handling of the shell and/or the terminal as formed in this way, Document WO 2011/148087 provides for the shell to have a side that covers the lateral edge of the telephone through which the SIM card is accessible.

The present invention provides an alternative to that solution.

### OBJECT AND SUMMARY OF THE INVENTION

Thus, in a first aspect, the invention provides a shell adapted to receive a mobile telephone in releasable manner, said mobile telephone having a slot arranged in a lateral edge for enabling a subscriber identity card to be inserted in the mobile telephone, said shell comprising:
means arranged on a bottom-forming wall of the shell to receive and hold a near field communication device and an antenna associated with the near field communication device;
a wire interface having a first end for connection to the communication device and a second end provided with a plurality of electrical contacts; and
a support having the second end of the wire interface fastened thereto, the support being adapted to receive the subscriber identity card so as to connect the electrical contacts of the second end with corresponding electrical contacts of the subscriber identity card.

This solution provides a shell that is to receive a mobile telephone in removable manner, the shell having a support incorporating one end of the wire interface provided with electrical contacts and on which the SIM card is positioned so that the contacts of the SIM card are connected to the corresponding contacts at the end of the wire interface. The wire interface incorporated in the support thus lies in series between the mobile terminal and the SIM card.

In the meaning of the invention, the term “wire interface” covers any set of physical connections between two electrical contacts. By way of example, such a wire interface may be constituted by a sheet of plastics material having a set of connection wires embedded therein, in known manner.

The invention thus proposes a solution that is an alternative to that described in Document WO 2011/148087, making it possible firstly to fit an already-existing mobile telephone so as to enable it to offer contactless functions, and secondly to protect the wire interface used for connecting the NFC device to the SIM card.

In an embodiment, the shell has a second support mounted on a rim-forming wall of the shell, said second support having a plurality of connection means, each of said connection means being arranged to connect a contact of the mobile terminal to one of said electrical contacts of the second end of the wire interface, said second support being adapted to be inserted in the slot arranged in the lateral edge of the mobile telephone.

This embodiment presents the advantage of making contact between the second end of the wire interface and the subscriber identity card more reliable. There is less risk of the subscriber identity card being poorly positioned relative to the second end of the wire interface. Furthermore, such an embodiment gives rise to smaller constraints on dimensions, in particular on the thickness of the support on which the second end of the wire interface is fastened and which is intended to be inserted in the slot arranged in the lateral edge of the mobile telephone.

In another embodiment, the invention provides a shell adapted to receive a mobile telephone in releasable manner, the mobile telephone having a slot arranged in a lateral edge for enabling a subscriber identity card to be inserted in the mobile telephone. This shell is remarkable in that it comprises:
means arranged on a bottom-forming wall of the shell to receive and hold a near field communication device and an antenna associated with the near field communication device;
a wire interface having a first end for connection to the communication device and a second end provided with a plurality of electrical contacts; and
a support, mounted on a rim-forming wall of the shell, and having the second end of the wire interface fastened thereto, the support being adapted to receive the subscriber identity card so as to connect the electrical contacts of the second end with corresponding electrical contacts of the subscriber identity card;

the assembly formed by the support having the second end of the wire interface fastened thereto and the subscriber identity card received on the support being adapted to be inserted in the slot arranged in the lateral edge of the mobile telephone.

In the invention, this support is dimensioned so that the assembly, as formed by the support fastened to the end of the wire interface with the contacts and including the SIM card in position on the support, is capable of being inserted in the slot arranged in the lateral edge of the mobile telephone as provided by the manufacturer of the telephone for receiving the SIM card tray. The invention thus proposes an architecture for a mobile telephone that is very flexible, making it easy to change the mobile telephone, or indeed the SIM card, independently of the NFC components that are provided by the shell.

In a preferred embodiment of the invention, the support used in the invention is of a shape that is similar or identical to that of the SIM card tray provided by the manufacturer of the mobile telephone. This makes it possible not only to facilitate positioning the SIM card on the support, but also to guarantee that the support can be inserted together with the SIM card in the mobile telephone via the slot provided in the lateral edge of the mobile telephone. As a result, the invention can be implemented without any modification to the mobile telephone.

In accordance with the invention, the wire interface serving to connect together the NFC device and the SIM card is completely protected against any external attack, whether via the shell or via the mobile telephone while the support is being inserted in the telephone: there is no risk of the wire interface being broken or damaged in the event of an impact or of the shell being roughly handled.

Furthermore, once the telephone is properly positioned in the shell, the assembly constituted by the NFC device and the wire interface is fully incorporated therein and completely invisible from the outside. The invention thus provides a strong and compact solution for adding NFC functions to an existing mobile telephone.

Furthermore, inserting the support in the mobile telephone and inserting the mobile telephone in the shell presents no difficulty for the user. The user performs actions that are similar to those needed, when the telephone does not have NFC functions, for inserting a conventional tray with a SIM card in the mobile telephone.

It should be observed, that by associating the NFC device with the SIM card, the invention makes it possible to make secure the data that is exchanged during NFC communications by making use of the security inherent in the SIM card, and also makes it possible to share the power supply of the SIM card for the purpose of powering the NFC device, while leaving free access to the other functions made available by the mobile telephone, such as for example positioning the mobile telephone on a station for charging it, etc.

In a particular embodiment, the support is mounted on the wall of the shell by a pivot connection pivotable about an axis extending along said wall.

This pivot connection enables the support on which the SIM card is received to be hinged relative to the wall so as to enable it to be inserted easily in the slot of the mobile telephone.

In a variant, the support may be mounted on the wall by a rigid connection. Thus, the support may be adhesively bonded or soldered to the wall, for example.

This variant is particularly simple to make.

To facilitate inserting the support in the mobile telephone when it is envisaged to use a rigid connection between the support and the wall of the shell, the invention proposes variant embodiments that are relatively simple and particularly effective, and that can be implemented when designing the shell.

Thus, in a first variant, at least one wall of the shell is made of a material that is flexible and deformable. This wall is preferably the wall of the shell on which the support is mounted.

This first variant embodiment helps positioning the support in the mobile telephone when the SIM card is received on the support. By deforming the flexible wall of the shell on which the support is positioned, it is easy to bring the support into the slot arranged in the lateral edge of the telephone.

Furthermore, this first variant advantageously makes it possible to limit manufacturing costs associated with making a shell of the invention. It makes it easier to reuse molds for fabricating existing shells that are not in accordance with the invention.

In a second variant, the shell of the invention may be constituted by at least two distinct portions that are assembled together, one of the portions including the means arranged on the bottom-forming wall of the shell, the wire interface, and the support.

For example, the other portion may comprise a rim-forming wall of the shell opposite from the wall on which the support is mounted.

Subdividing the shell appropriately in this way makes the action of inserting the support in the mobile telephone simple. Thereafter, the second portion of the shell is assembled with the first portion so as to reconstitute the shell. The two portions may be assembled in particular by means of conventional connection clips.

This two-portion structure for the shell also makes it easier to establish other contacts available for the mobile telephone, such as in particular contact with a docking station.

It should be observed that using a shell with a wall made of flexible, deformable material or a shell made up of a plurality of portions is particularly suitable when the support is rigidly mounted relative to the rim-forming wall of the shell, even though both of these two alternatives can also be envisaged when the support is mounted on the wall of the shell via a pivot connection.

In a particular embodiment, at least one of the walls of the shell includes a setback of shape adapted to receive at least a portion of the wire interface.

This embodiment enables the wire interface to be protected more effectively.

Preferably, the depth of this setback is of dimensions such that once the wire interface is inserted in the setback it is flush with the (inside) surface of the shell, i.e. it is level with that surface.

This ensures that the wire interface is well held and protected in the shell.

Furthermore, the wire interface may be held in the setback with the help of resin.

The wire interface is thus made stronger and better at withstanding potential external attack, e.g. in the event of the shell being dropped.

In a particular embodiment, the bottom-forming wall of the shell includes a card setback of shape adapted to receive and hold a removable subscriber identity card support of the mobile telephone.

Since the support of the invention is inserted as a replacement for the SIM card tray initially provided by the manufacturer of the telephone, this embodiment enables the user of the mobile telephone to avoid losing the tray while using the shell.

In another particular embodiment, the means arranged on the bottom-forming wall of the shell include an NFC device setback of shape adapted to receive and hold the near field communication device and the antenna associated with the device.

It is thus possible to have complete control in advance over the position of the NFC device and its antenna, thereby making it easier to optimize certain performance aspects associated with the length of the wire interface.

In addition, the means arranged in the bottom-forming wall of the shell may hold the near field communication device and the antenna associated with the near field communication device with the help of resin.

Thus, once in position, the near field communication device and its antenna can no longer move, even in the event of the shell or the terminal being moved suddenly. The NFC communication device is also better protected by the resin.

In an embodiment of the invention, the wall of the shell on which the support is mounted includes a through slot suitable for passing the subscriber identity card.

This slot makes it easy to extract the SIM card from the support or to insert it thereon.

In a second aspect, the invention provides a mobile terminal adapted to communicate over a mobile telecommunications network and to handle near field communications, said mobile terminal comprising:
a mobile telephone provided with a slot arranged in a lateral edge and enabling a subscriber identity card to be inserted in the mobile telephone; and
a shell of the invention adapted to receive the mobile telephone in removable manner.

Such a terminal makes it possible to make use both of mobile telephony functions and of NFC type functions.

The mobile telephone is thus provided with NFC functions even if it was not initially designed to have them: for this purpose it suffices to associate the telephone with a shell of the invention. The shell also serves advantageously to protect the terminal against possible impacts or external attacks.

In a third aspect, the invention also provides a communications system comprising a plurality of mobile terminals of the invention.

In other embodiments, it is also possible to envisage that the shell, the mobile terminal, and the communications system of the invention present in combination some or all of the above-specified characteristics.

### BRIEF DESCRIPTION OF THE DRAWINGS

Other characteristics and advantages of the present invention appear from the following description made with reference to the accompanying drawings which show embodiments having no limiting character. In the figures:

FIGS. 1, 2A, and 2B show in highly diagrammatic manner a terminal and a shell in accordance in with the invention in a first embodiment;

FIGS. 3A and 3B show a terminal and a shell in accordance with the invention in a second embodiment;

FIG. 4 shows a terminal and a shell in accordance with the invention in a third embodiment; and

FIG. 5 is a diagrammatic view of a terminal and a shell in accordance with the invention in a fourth embodiment.

### DETAILED DESCRIPTION OF THE INVENTION

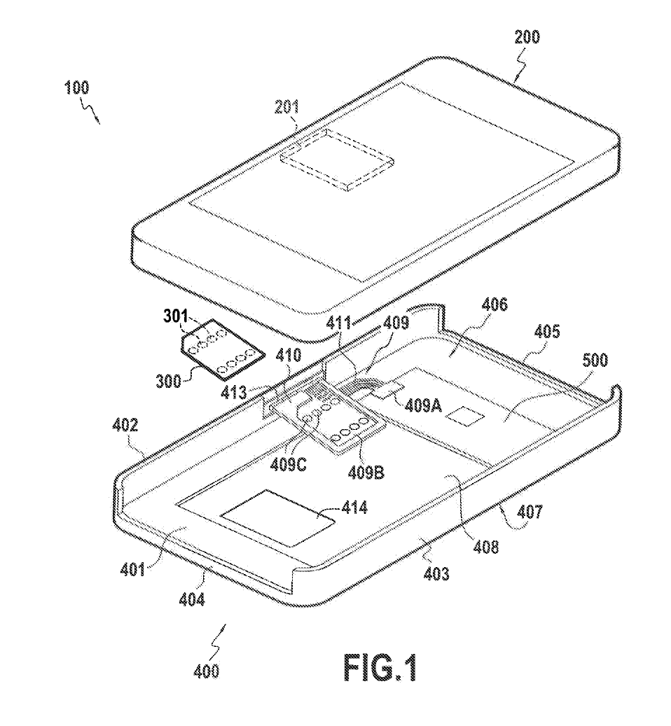

FIG. 1 shows a mobile terminal 100 in accordance with the invention, adapted to communicate over a mobile telecommunications network (not shown) and to handle near-field communications, in a first embodiment of the invention.

In accordance with the invention, the mobile terminal 100 comprises:
a mobile telephone 200 suitable for receiving a subscriber identity card 300 (in other words a SIM card) in order to be able to communicate over the mobile telecommunications network; and
a shell 400 in accordance with the invention that is adapted to receive the mobile telephone 200 in removable manner, thereby enabling the telephone to be adapted in such a manner as to impart NFC type contactless communication functions thereto.

In the invention, the term “removable” is used to mean that the telephone 200 can be received in temporary manner by the shell 400, in other words that it can be freely inserted in and removed from the shell 400.

The mobile telephone 200 may be any telephone provided with a slot 201 arranged in a lateral side. The slot 201 serves to insert the SIM card 300 into the mobile telephone 200 via the SIM card tray (not shown) provided with the mobile telephone.

The SIM card 300 has a plurality of electrical contacts 301 that, on being inserted in the slot 201 by means of the SIM card tray, are connected to corresponding contacts of the mobile telephone 200. In known manner, these electrical contacts 301 serve in particular to power the SIM card electrically and also to exchange data via standardized communications protocols, such as the single wire protocol (SWP). Since such contacts are known to the person skilled in the art, they are not described in greater detail herein.

It should be observed that there is no limitation concerning which lateral edge of the mobile telephone 200 has the slot 201: the slot may be arranged in any of the lateral edges of the telephone 200 (left, right, top, or bottom relative to the direction in which the mobile telephone is used). The person skilled in the art will have no difficulty in adapting the shell of the invention to take account of the slot being in some other position on the mobile telephone 200.

The shell 400 has a bottom-forming wall 401 for covering the rear face of the mobile telephone 200, which wall is surrounded by one or more rim-forming walls 402-405. These rim-forming walls are to fit around the lateral edges of the mobile telephone 200 so as to hold it against the bottom-forming wall 401 of the shell when the telephone is positioned in the shell 400.

The shell 400 also has an inside surface 406 and an outside surface 407 opposite from its inside surface 406, which surface may be of any form.

Thus, in the example shown in FIG. 1, the bottom-forming wall 401 of the shell, beside the outside surface 407 of the shell, is in the form of a surface that is flat, smooth, and rigid. It is surrounded by the four rim-forming walls 402-405 that are likewise rigid, and substantially perpendicular to the bottom-forming wall 401 of the shell. Openings may also be made in the walls 402-405 so as to give access to various functions of the mobile telephone, such as for example to connection means enabling the mobile telephone 200 to be positioned on a docking station (which means are generally situated in the bottom lateral edge of the mobile telephone 200), to buttons for increasing or reducing the sound level of calls, to the lens of a camera (generally positioned beside the outside surface 407 of the shell in the bottom-forming wall 401 of the shell), etc.

In accordance with the invention, the shell 400 also comprises:
means 408 arranged on the bottom-forming wall 401 of the shell beside the inside surface 406 of the shell 400 for the purpose of receiving and holding a near field communication device (i.e. an NFC device) and an antenna associated with this communication device. In the description below, and for the sake of simplification, the term “NFC assembly” 500 is used to designate the assembly constituted by the NFC device and the antenna associated with the device;
a wire interface 409 for connecting the NFC communication device to the SIM card 300. This wire interface 409 has a first end 409A connected to the NFC device, and a second end 409B with a plurality of electrical contacts 409C; and
a support 410 mounted on the rim-forming wall 402 of the shell where the end 409B of the wire interface 409 is fastened. The support 410 is adapted to receive the SIM card 300 by positioning it on the end 409B of the wire interface 409 incorporated in the support 410 so as to establish electric contact between the electrical contacts 409C of the wire interface and the corresponding electrical contacts 301 of the SIM card 300 (in other words so as to connect the electrical contacts 409C of the wire interface with the corresponding electrical contacts 301 of the SIM card 300).

In the presently-described embodiment, the means for receiving and holding the NFC device comprise a setback for the NFC device 408 that is machined in the thickness of the shell 400 in its inside surface 406, and that is shaped to receive and hold the NFC assembly 500. The dimensions of the setback 408 match the dimensions of the NFC assembly. In particular, the depth of the setback is substantially equal to the thickness of the NFC device so that the device is flush with the inside surface of the shell when mounted therein. The NFC assembly 500 is held in the setback 408 with the help of resin.

In a variant, it is possible to envisage other configurations for the NFC assembly 500 and for the means 408. For example, the NFC device and its antenna 500 may be designed on a substrate that is received and held in position by the means for receiving and holding the NFC device by being embedded therein.

Other means enabling the NFC device and its antenna to be held against the bottom-forming wall of the shell could also be envisaged, such as for example adhesive, mechanical fasteners, etc.

By way of example, the wire interface 409 is a sheet of plastics material holding a plurality of connection wires within the sheet.

In the presently-described embodiment, the portion of the wire interface 409 that runs along the inside surface 406 of the shell to the support 410 is received in a setback 411 formed in the walls 401 and 402 of the shell, so as to be protected.

This setback 411 is made in the inside surface 406 of the shell 400. It is of a shape that is adapted to receive the interface 409. More precisely, its depth, its width, and its length are selected in this example so that the wire interface 409, when received in the setback 411, is flush with the inside surface 406 of the shell 400. This ensures that the wire interface 409 does not project from the inside surface 406 of the shell: consequently, it is better protected against potential external attacks.

The wire interface 409 is also held in the setback 411, e.g. with the help of resin.

As mentioned above, the wire interface 409 has a first end 409A connected to the NFC device in conventional manner, and a second end 409B provided with a plurality of electrical contacts 409C that are to be connected to the corresponding contacts of the SIM card 300. Such a sheet is described in greater detail, in particular in Document WO 2011/148086, and is therefore not described in greater detail herein.

The second end 409B of the wire interface 409 with the electrical contacts 409C is fastened, e.g. by means of adhesive, to the support 410 securely mounted on the rim-forming wall 402. Naturally, other means enabling the end 409B to be fastened in the support 410 could be envisaged, such as a mechanical fastener.

The support 410 has a portion (e.g. made of metal or of plastics material) of a shape that is adapted to receive the SIM card 300 and to hold it in contact with the end 409B of the wire interface. By way of example, such a shape is similar to the shape of a conventional tray for a SIM card 300.

Nevertheless, it should be observed that unlike conventional SIM card trays, the support 410 is “solid” in that it incorporates the end 409B of the wire interface. It also has a setback made above the end 409B and of shape similar to the shape of the SIM card 300 so as to be capable of receiving the SIM card easily over the end 409B of the wire interface 409 and so as to be able to hold the SIM card easily in position.

In a variant, it is possible to envisage other shapes for the support 410 that serve to receive the SIM card 300 on the end 409B, and also other means for holding the SIM card 300 in position once it has been installed on the end 409B.

The support 410 is mounted on the rim wall 402 to coincide with the lateral edge of the mobile telephone 200 in which the slot 201 is made. More precisely, in the embodiment of FIGS. 1, 2A, and 2B, the support 410 is mounted on the rim-forming wall 402 of the shell via a pivot connection that pivots about an axis extending along this wall 402. The support 410 projects towards the inside of the shell, i.e. towards the wall 403 of the shell that is opposite from the wall on which it is mounted.

Such a pivot connection may be made in particular by means of a conventional hinge 413 received in the thickness of the rim wall 402 of the shell 400. This guarantees that the lateral edges of the mobile telephone 200, when it is in place in the shell 400, come into contact with the rim-forming walls 402-405 of the shell 400 so as to hold the mobile telephone 200 in position.

In accordance with the invention, in order to impart NFC functions to the mobile telephone 200, the assembly as formed by the support 410 on which the end 409B is fastened and including the SIM card 300 positioned on the support 410 is inserted into the mobile telephone 200 via the slot 201, it being understood that the contacts 409C of the wire interface are then in connection with the corresponding contacts 301 of the SIM card 300.

For this purpose, the dimensions of the support 410 and of the wire interface 409 are selected so that once the SIM card is in position it is possible to insert the assembly in the slot 201 provided in the mobile telephone 200. In other words, the dimensions (i.e. the thickness, the width, and the length) of the assembly constituted by the support 410 and the SIM card 300 in position on the support 410 should be less than or equal to the dimensions of the slot 201. Nevertheless, if necessary, they could be slightly greater than the dimensions of an assembly constituted by a conventional SIM card tray with the SIM card in position on the tray, providing it is possible for the assembly to be inserted in the slot in the telephone. It should be observed that the dimensions of the slot 201 are determined by the manufacturer of the mobile telephone 200.

The position of the support 410 relative to the height of the wall 402 is determined as a function of the dimensions of the mobile telephone 200, so as to enable the support 410 to be inserted in the slot 201.

The pivot connection 413 used for mounting the support 410 on the wall 402 serves to make it easier for the assembly constituted by the support 410 with the end 409B of the wire interface and the SIM card 300 fastened thereto to be inserted in the slot 201, as shown in FIGS. 2A and 2B. This presents a non-negligible advantage when the walls of the shell 400 are made of material that is rigid.

Specifically, the presence of this pivot connection makes it possible to raise the support 410 having the SIM card 300 positioned thereon so as to be able to insert it in the mobile telephone 200 via the slot 201 (cf. FIG. 2A). Once the assembly constituted by the support and the SIM card has been inserted in the mobile telephone 200, the telephone is then moved towards the bottom-forming wall 401 of the shell and is embedded in the shell 400 on the NFC assembly 500, with this being made possible by the pivot connection (cf. FIG. 2B).

The mobile terminal 100 formed by the mobile telephone 200 inserted in the shell 400 is thus capable both of communicating over the mobile telecommunications network with the help of the SIM card 300, and also of handling near field communications with the help of the NFC assembly 500.

In a variant, other means for making the pivot connection could be used to fasten the support 410 on the rim-forming wall 402 of the shell.

Thus, in a first variant, it is possible to envisage lugs secured to the wall 402 and positioned on either side of the support 410 in the thickness of the wall 402.

In a second variant, it is possible to envisage one or more straps fastened on either side of the support 410 (thus passing through the support 410), or fastened at one end to the wall 402 and at the other end to the support 410 (via the metal or plastics portion of the support 410).

It should also be observed that the above-described pivot connection enabling the support 410 to be secured to the wall 402 need not be exclusive, i.e. it is possible to envisage that the support 410 is fastened to the wall 402 by using means that implement connections of other types in addition to the pivot connection. Thus, for example, these means may combine the pivot connection with a sliding connection along all or part of the height of the wall 402.

In another embodiment of the invention, the support is mounted on a rim-forming wall of the shell via a rigid connection, i.e. a connection that is stationary relative to the wall.

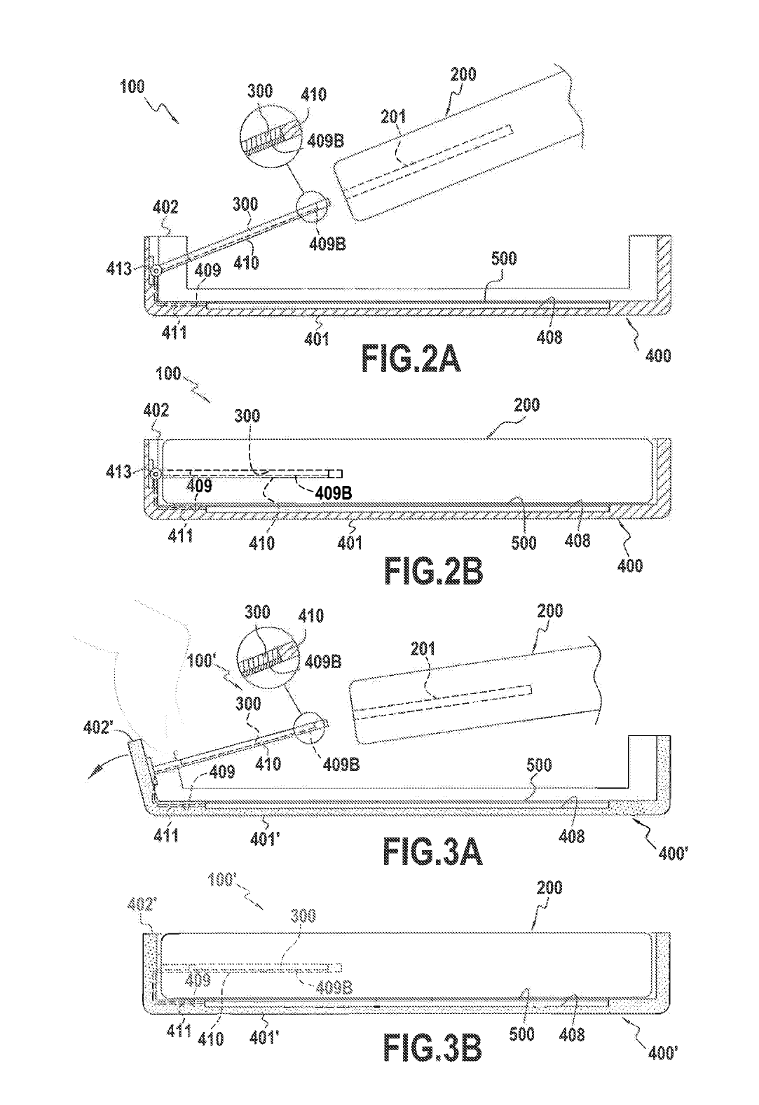

Thus, FIGS. 3A and 3B show a mobile terminal 100′ in a second embodiment of the invention in which a rigid connection is used for fastening the support 410 to the rim-forming wall 402′ of the shell. For the sake of simplification, identical references are used to designate elements of the mobile terminal 100′ that are identical to elements of the mobile terminal 100 shown in FIGS. 1, 2A, and 2B.

The shell 400′ shown in FIGS. 3A and 3B differs from the above-described shell 400 in that:
firstly, it includes at least one wall, namely the rim-forming wall 402′ on which the support 410 is mounted, that is made of a material that is flexible and deformable, e.g. such as rubber (in the example, shown all of the walls of the shell 400′ are made of this material for the sake of simplification); and
secondly, the support 410 on which the end 409B of the wire interface 409 is fastened is mounted relative to this wall by a connection that is rigid. By way of example, such a rigid connection is provided by adhesively bonding the support 410 to the wall 402′.

In spite of the presence of a rigid connection between the support 410 and the wall 402′, the use of a flexible and deformable material for the wall 402′ nevertheless enables the assembly as constituted by the support 410 on which the SIM card 300 is positioned to be inserted easily in the slot 201 of the mobile telephone 200.

Specifically, in order to position the support 410 in the slot 201 of the telephone, it suffices to deform the wall 402′ of flexible material so as to move it away from its rest position in order to cause the support 410 to be inclined (cf. FIG. 3A). The support 410 as inclined in this way can be inserted easily in the slot 201 of the mobile telephone 200.

The mobile telephone 200 in which the support 410 together with the SIM card 300 inserted therein is then moved towards the bottom-forming wall 401′ of the shell 400′, and is embedded in the shell on the NFC assembly 500 (cf. FIG. 3B), possibly by flexing the flexible wall 402′ once more, if necessary.

The mobile terminal 100′ formed by the mobile telephone 200 inserted in the shell 400′ is thus suitable both for communicating over the mobile telecommunications network with the help of the SIM card 300 and also of handling near field communications with the help of the NFC assembly 500.

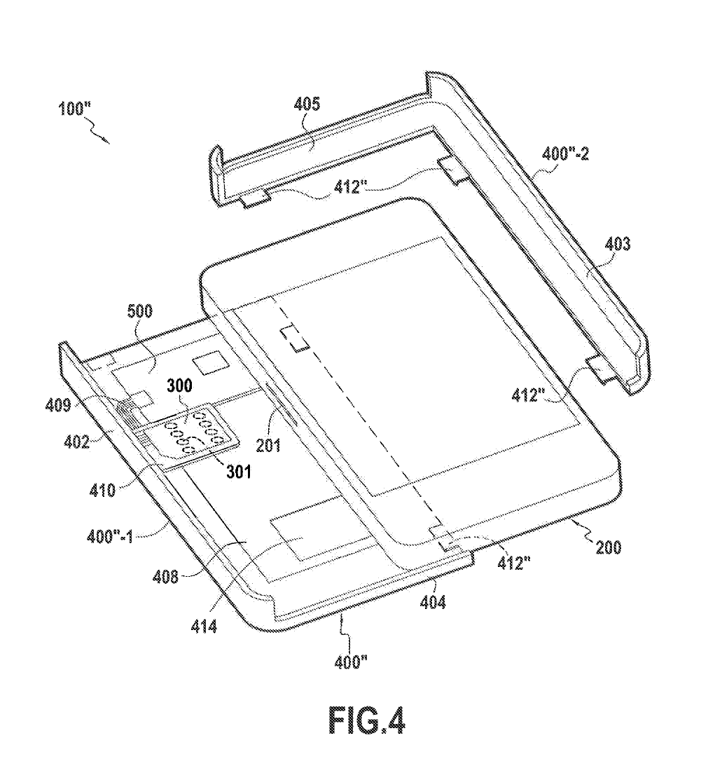

FIG. 4 shows a third embodiment of the invention, in which the support 410 is mounted by a rigid connection on the rim-forming wall 402 of a shell 400″ in accordance with the invention. In this third embodiment, the shell 400″ is made entirely out of a rigid material, such as a plastics material, for example. For the sake of simplification, identical references are used for designating elements of the mobile terminal 100″ that are identical to elements of the mobile terminal 100 shown in FIGS. 1, 2A, and 2B.

In this third embodiment, in order to facilitate inserting the assembly as constituted by the support 410 having the end 409B of the wire interface and the SIM card 300 fastened thereon, the shell 400″ is made up of a plurality of distinct portions that are assembled together. Apart from the fact that the support 410 is fastened to the wall 402 of the shell 400″ via a rigid connection, the other elements of the shell and of the terminal 100″ are similar or identical to elements of the shell 400 and of the terminal 100.

More precisely, in the example shown in FIG. 4, the shell 400″ is made up of two portions, namely:
a first portion 400″-1 of rectangular shape comprising the means 408, the wire interface 409, and the support 410. In this example, this first portion 400″-1 includes the wall 402 and almost all of the rim-forming wall 404 of the shell 400″ that is contiguous with the wall 402; and
a second portion 400″-2 that is L-shaped, including the rim-forming wall 403 of the shell 400″ that is opposite from the wall 402 on which the support 410 is mounted, the remainder of the wall 404, and the wall 405 of the shell 400″.

As shown in FIG. 4, the portions 400″-1 and 400″-2 are thus distinct and complementary. They are assembled together in reversible manner (i.e. they can be assembled together and separated without being damaged), by means of a plurality of fastener clips 412″ so as to constitute the shell 400″.

It should be observed that no limitation is associated with the means 412″ used for assembling together the portions 400″-1 and 400″-2 in order to constitute the shell 400″. Other assembly means could naturally be used, e.g. such as self-gripping tongues, etc.

In this third embodiment, in order to position the support 410 in the slot 201 of the mobile telephone 200, it suffices to separate the two portions 400″-1 and 400″-2 of the shell 400″. The mobile telephone 200 is then slid along the bottom wall 401 towards the support 410 (cf. FIG. 4), until the support 410 is fully inserted in the slot 201.

Once the support 410 is inserted in the slot, the second portion 400″-2 is positioned around the mobile telephone 200 and the portions 400″-1 and 400″-2 are assembled together by the fastener clip 412″ so as to reconstitute the shell 400″.

Naturally, the portions 400″-1 and 400″-2 may be of shapes other than those shown in FIG. 4. Thus, by way of example, the second portion 400″-2 may be rectangular in shape and may include the wall 403 and two portions that are of the same dimensions as the walls 404 and 405 and that are contiguous with the wall 403.

The mobile terminal 100″ that is obtained after assembling together the two portions is thus capable firstly of communicating over the mobile telecommunications network with the help of the SIM card 300 and also of handling near field communications with the held of the NFC assembly 500.

In the three above-described embodiments, it should be observed that the support 410 on which the SIM card 300 is positioned is itself inserted in the slot 201 as a replacement for the SIM card tray that is delivered with the mobile telephone 200.

Advantageously, provision is made in these three embodiments for a card setback 414 to be made in the inside surface of a shell 400, 400′, or 400″ in its bottom-forming wall, the setback being of a shape that is suitable for receiving and holding the removable SIM card tray of the mobile telephone 200 that is not used when the mobile telephone 200 is inserted in the shell.

This card setback 414 thus serves to store the SIM card tray of the mobile telephone 200 while the support 410 is being used to impart NFC functions to the mobile telephone 200. This serves to prevent the user of the mobile telephone 200 losing the tray.

Furthermore, in another embodiment that is not shown in the figures, it is possible to provide a through slot in the rim-forming wall on which the support is mounted, this slot serving to pass the SIM card. Such a slot makes it possible advantageously to be able to extract the SIM card from the support, or on the contrary to insert it onto the support inside the mobile telephone without it being necessary to remove the telephone from the shell. This slot is arranged in the wall of the shell so as to be in register with the expected or actual position of the SIM card relative to the support.

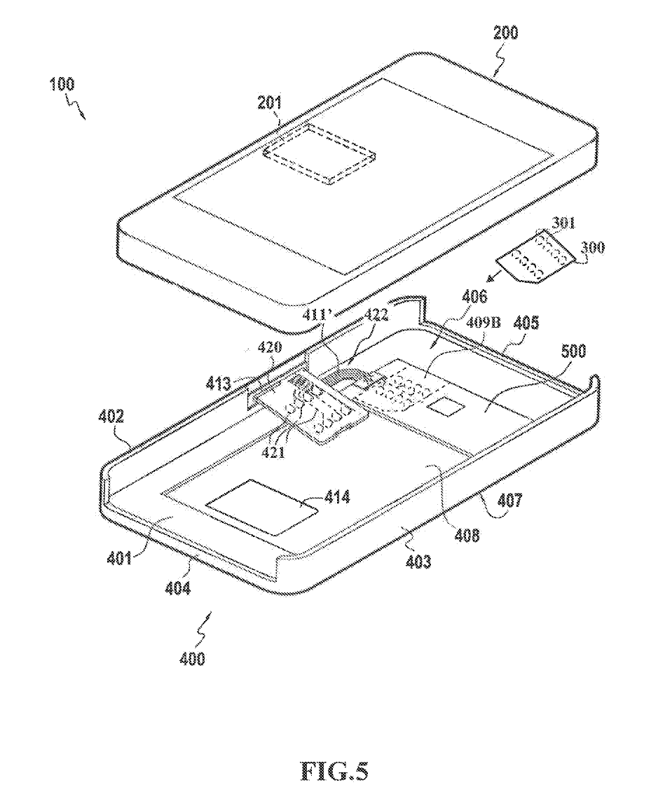

In another embodiment that is shown in FIG. 5, the subscriber identity card 300, the support (not shown in FIG. 5), and the second end of the wire interface 409B are geographically offset in the shell 400, 400′, 400″. For example, another setback (not shown in FIG. 5) in the shell 400, 400′, 400″ made in the inside surface of the shell 400, 400′, 400″ is of a shape that is adapted to receive the support having the second end 409B of the wire interface fastened thereto and that receives the subscriber identity card 300. For reasons of readability, only the second end 409B of the wire interface is shown. It is positioned on the support. It can be understood that the support is less constrained in terms of thickness than in the embodiment described with reference to FIGS. 1 to 4. In an embodiment, the support is contained in the setback.

In the example described with reference to FIG. 5, the support having the second end 409B of the wire interface fastened thereto is situated in the proximity of the near field communication device 500.

In this embodiment, a second support 420 mounted on the rim-forming wall 402 of the shell has connection means 421 arranged to connect a contact of the mobile terminal (not shown in FIG. 5) when the second support 420 is inserted in the slot arranged in the lateral wall of the mobile terminal with a corresponding electrical contact of the second end 409B of the wire interface. In other words, when the connection means 421 are in contact with the mobile terminal, they extend the contacts of the mobile terminal to the second end 409B of the wire interface. The wire interface (not shown in FIG. 5) otherwise remains as described in Document WO 2011/148086. Together the connection means 421 form a second wire interface 422 taking the second support 420 to the second end 409B of the wire interface in a setback 411′ formed in the walls 401 and 402 of the shell.

It can be understood that in the embodiment in which the subscriber identity card 300 is geographically offset in the shell 400, 400′, 400″, the functions inherent to the wire interface remain identical.

This embodiment presents the advantage of making contact between the second end 409B of the wire interface and the subscriber identity card 300 more reliable. There is smaller risk of the subscriber identity card 300 being poorly positioned relative to the second end 409B of the wire interface. Furthermore, such embodiments put less constraints on dimensions, and in particular on the thickness, both of the support on which the wire interface is fastened and of the second support 420 that is to be inserted in the slot 201 arranged in the lateral edge of the mobile terminal. Thus, the invention makes it easy to impart NFC communications functions to any existing mobile telephone in addition to its functions of communicating over a mobile network. The mobile terminal obtained by assembling the shell of the invention, the subscriber identity card, and the mobile telephone can advantageously be incorporated in a communications system of the invention, comprising both mobile telephone network equipment such as base stations with which the terminal can communicate, and also one or more pieces of NFC equipment performing contactless applications with which the mobile terminal of the invention can communicate, using the NFC assembly incorporated in its shell.

1. A shell adapted to receive a mobile telephone in releasable manner, said mobile telephone having a slot arranged in a lateral edge for enabling a subscriber identity card to be inserted in the mobile telephone, said shell comprising:
a holder arranged on a bottom-forming wall of the shell to receive and hold a near field communication device and an antenna associated with the near field communication device;
a wire interface having a first end for connection to the communication device and a second end provided with a plurality of electrical contacts; and
a support having the second end of the wire interface fastened thereto, the support being adapted to receive the subscriber identity card so as to connect the electrical contacts of the second end with corresponding electrical contacts of the subscriber identity card.

2. A shell according to claim 1, wherein the support is mounted on a rim-forming wall of the shell, the assembly formed by the support having the second end of the wire interface fastened thereto and the subscriber identity card received on the support being adapted to be inserted in the slot arranged in the lateral edge of the mobile telephone.

3. A shell according to claim 1, having a second support mounted on a rim-forming wall of the shell, said second support having a plurality of connectors, each of said connectors being arranged to connect a contact of the mobile terminal to one of said electrical contacts of the second end of the wire interface, said second support being adapted to be inserted in the slot arranged in the lateral edge of the mobile telephone.

4. A shell according to claim 1, wherein the wall of the shell on which the support is mounted is made of a material that is flexible and deformable.

5. A shell according to claim 1, wherein said support is mounted on the wall of the shell by a pivot connection pivotable about an axis extending along said wall.

6. A shell according to claim 1, wherein said support is mounted on the wall by a rigid connection.

7. A shell according to claim 6 comprising at least two distinct portions that are assembled together, one of the portions including the holder arranged on the bottom-forming wall of the shell, the wire interface, and the support.

8. A shell according to claim 7, wherein the other portion comprises a rim-forming wall of the shell opposite from the wall on which the support is mounted.

9. A shell according to claim 7, wherein the portions are assembled together by connection clips.

10. A shell according to claim 1, wherein at least one of the walls of the shell includes a setback of shape adapted to receive at least a portion of the wire interface.

11. A shell according to claim 10, wherein the wire interface is held in the setback with the help of resin.

12. A shell according to claim 1, wherein the bottom-forming wall of the shell includes a card setback of shape adapted to receive and hold a removable subscriber identity card support of the mobile telephone.

13. A shell according to claim 1, wherein the holder arranged on the bottom-forming wall of the shell comprises an NFC device setback of shape adapted to receive and hold the near field communication device and the antenna associated with the device.

14. A shell according to claim 13, wherein the holder arranged in the bottom-forming wall of the shell holds the near field communication device and the antenna associated with the near field communication device with the help of resin.

15. A shell according to claim 1, wherein the wall of the shell on which the support is mounted includes a through slot suitable for passing the subscriber identity card.

16. A mobile terminal adapted to communicate over a mobile telecommunications network and to handle near field communications, said mobile terminal comprising:
a mobile telephone provided with a slot arranged in a lateral edge and enabling a subscriber identity card to be inserted in the mobile telephone; and
a shell according to claim 1 and adapted to receive said mobile telephone in removable manner.
